(19) United States
(12) Patent Application Publication
(10) Pub. No.: US 2004/0260550 A1
(43) Pub. Date: Dec. 23, 2004

(54) Audio processing system and method for classifying speakers in audio data

(76) Inventors: Chris J.C. Burges, Bellevue, WA (US); John C. Platt, Redmond, WA (US)

Correspondence Address: LYON & HARR, L.L.P, Suite 800, 300 Esplanade Drive, Oxnard, CA, 93036-1274, US

(21) Appl. No.: 10/600,475

(22) Filed: Jun. 20, 2003

(51) Int. Cl. G10L 13/00

(52) U.S. Cl. 704/259

(57) ABSTRACT

An audio processing system and method for classifying speakers in audio data using a discriminatively-trained classifier. In general, the audio processing system inputs audio data containing unknown speakers and outputs frame tags whereby each tag represents an individual speaker. The audio processing system includes a training system for training a discriminatively-trained classifier (such as a time-delay neural network) and a speaker classification system for using the classifier to segment and classify the speakers. The audio processing method includes two phases. A training phase discriminatively trains the classifier on a speaker training set containing known speakers and produces fixed classifier data. A use phase uses the fixed classifier data in the discriminatively-trained classifier to produce anchor model outputs for every frame of speech in the audio data. The anchor model outputs are mapped to frame tags to that all speech corresponding to a single frame tag comes from a single speaker.

### TECHNICAL FIELD

The present invention relates in general to audio processing and more particularly to an audio processing system and method for segmenting or identifying speakers in audio data using a discriminatively-trained classifier.

### BACKGROUND OF THE INVENTION

The speaker classification task is defined as either speaker segmentation or identification. In the speaker identification task, speech is mapped into a sequence of frame tags, where the identity of the speaker has a one-to-one relationship to the frame tags. A frame tag is defined to be an integer tag that is attached to each input audio frame, where the integer uniquely identifies a speaker. A frame is a fixed length contiguous section drawn from the input audio data. The goal is to accurately and quickly segment the audio data by speaker. In other words, for each speaker contributing to the audio data, it is desirable to account for each second of audio data by mapping to a certain speaker or to non-speech (such as silence). This can be achieved by constructing a list of start and stop times for when each speaker was speaking. In the speaker identification task, the speakers previously registered their voice with the system, and this registration is used to identify the speaker.

In the speaker segmentation task, no registration is performed and the speaker's identity is completely unknown. The goal of speaker segmentation is not for the system to identify each speaker, but rather for the system to classify speech in the audio data by individual speaker (such as speaker number one, speaker number two, etc.). By way of example, for a given recording of a meeting, each speaker in the audio data can be classified into different classifications corresponding to an individual speaker such that a user can manually identify which classification of audio corresponds to which speaker.

Speaker identification and segmentation of audio data is an important technique that has several applications. For example, speaker segmentation and identification may be used in applications such as speech indexing, speech searching, and for segmenting recorded meetings by speaker. In general, speaker segmentation and identification involves processing audio data containing speech from one or more speakers, where the number and identity of the speakers is unknown beforehand.

There are a number of approaches currently used to segment and identify speakers in audio data. One such approach uses anchor models. In general, an anchor model is a classifier trained to distinguish between a number of known classes. The output of the classifier then is used as the input to another machine-learning algorithm (such as clustering) where the algorithm typically is operating on classes that are outside the known classes. In other words, the anchor model is trained on a training set containing a set of speakers and then the model is used on new speakers that are not in the training set.

Most current anchor model approaches use a Gaussian Mixture Model (GMM) as the anchor model. One problem with using a GMM as an anchor model, however, it that a GMM is not inherently discriminative. Although the GMM is used discriminatively, it is not trained discriminatively. In other words, the GMM is not trained to say that one speaker is not like another speaker. Instead, the GMM is trained to say that a speaker is like certain speaker, more like that certain speaker, or even more like the certain speaker. The GMM only outputs probabilities that indicate the likelihood that the current speaker is like a certain speaker. Training with the GMM approach tends to be slow.

Other approaches to speaker segmentation and identification use techniques borrowed from speech recognition. The problem with these approaches, however, is that the goal in speech recognition is the opposite of the goal in speaker segmentation and identification. Namely, in speech recognition, the goal is to enhance any linguistic information in the audio data and repress individual speaker information. For speaker segmentation and identification, it is just the opposite. In particular, the goal in speaker segmentation and identification is to repress linguistic information and enhance individual speaker information.

Another problem with applying speech recognition techniques to speaker segmentation and identification is that the length of the audio data examined by speech recognition techniques typically is quite short. In particular, speech recognition techniques typically divide audio data into approximately 20 millisecond frames (or windows). Decisions then are made based on these small 20 millisecond frames. The speech recognition techniques use these small windows because linguistic information (such as phonemes) of human speech can be as short as 20 milliseconds and it is undesirable to use longer frames because important linguistic information may be missed. When applied to speaker segmentation and identification, however, these small 20 millisecond frames make it difficult to glean individual speaker information from the audio data.

Still other speaker segmentation and identification approaches use silence between speakers to segment and classify the speakers. This technique can be unreliable, however, because in situations where there are groups of speakers (such as in a meeting) people generally tend to interrupt each other. In these situations, there is no silence between speakers. Therefore, there exists a need for a speaker'segmentation and identification approach that is fast enough to be used in real time, avoids the use of GMMs as anchor models, uses relatively wide frames when processing audio data, and does not require individual training data for each speaker (when solving the speaker segmentation task)

### SUMMARY OF THE INVENTION

The invention disclosed herein includes an audio processing system and method for classifying speakers in audio data. The audio processing system and method provide a framework for labeling audio segments by speaker without requiring individual speaker training sets. The audio processing system and method use a discriminatively-trained classifier (such as a time-delay neural network classifier) as a set of anchor models. This discriminatively-trained classifier is trained only from a general training set of speakers. The system and method use a classifier that takes input over a relatively wide time window, so that the speech can be quickly and accurately classified. Moreover, the audio processing system and method is fast and can be used to process audio data in real time.

The audio processing system and method disclosed herein uses a discriminatively-trained classifier to distinguish between speakers. The classifier is trained on a variety of known speakers in order to obtain classifier parameters. When the discriminatively-trained classifier is a neural network, the classifier parameters are typically weights of the neural network. The audio processing system and method generate features by using anchor models of speakers and determining how close the current speaker is to each one of those anchor models. The audio processing system and method inputs speech from speakers that has never been heard before by the system and clusters the data into as many classifications as needed such that each class corresponds to an individual speaker.

In general, the audio processing system includes a training system and a speaker classification system. The training system trains the discriminatively-trained classifier using a speaker training set containing a plurality of known speakers. When the discriminatively-trained classifier is a neural network, the training is done by minimizing a cross entropy error metric. In an alternate embodiment, the neural network is trained by minimizing a mean-squared error metric. The output of the training system is the classifier parameters (such as neural network weights).

The classifier parameters are used by the discriminatively-trained classifier in the speaker classification system. The input to the speaker classification system is audio data containing speakers that may not be known to the system, and typically were not used to the train the discriminatively-trained classifier. The discriminatively-trained classifier is applied to the audio data to produce anchor model outputs. These anchor model outputs are estimates of how close portions of the audio data are to speakers in the speaker training set. The anchor model outputs are then mapped to frame tags corresponding to individual speakers in the audio data.

The training system includes an audio pre-processing module that generates input feature vectors for the discriminatively-trained classifier. The audio pre-processing module is used in both the training and validation system and the speaker classification system, so that the discriminatively-trained classifier sees the same type of input during a use phase as it did during training. An error module computes a difference between output from the discriminatively-trained classifier and the correct frame tags from the speaker training set. An adjustment module adjusts weights of the discriminatively-trained classifier (assuming the discriminatively-trained classifier is a neural network) and this continues iteratively until the difference between the discriminatively-trained classifier output and the correct frame tags is small. When this occurs, the weights are fixed to be used later by the discriminatively-trained classifier in the speaker classification system.

The speaker classification system also contains the audio pre-processing module. The audio pre-processing module includes a frame module that divides the audio data into a plurality of frames. Preferably, each of these frames is at least 32 milliseconds in duration. A spectral analysis module of the audio pre-processing module performs spectral analysis on each frame to produce input spectral feature. The spectral features are processed by a spectral feature processor to extract spectral feature magnitudes. These magnitudes are averaged by an averaging module and processed by an automatic gain control module. The automatic gain control module keeps the energy of each frame at an approximately constant level. A dynamic threshold module sets upper and lower boundaries on the energy to alleviate spurious scaling discrepancies. The outputs of the audio pre-processing module are the input feature vectors for the discriminatively-trained classifier.

A normalization module is also included in the speaker segmentation and classification system. The normalization module takes outputs from before the final nonlinear layer of the discriminatively-trained classifier to produce modified feature vectors. A unit sphere module maps the modified feature vectors to a unit sphere to produce feature vectors having unit length. The speaker segmentation and classification system also includes a temporal sequential smoothing module that removes errors from frame tags using temporal information. The temporal sequential smoothing module inputs a set of clustered data points from the feature vectors. A data point selection module selects a data point from the set. A neighboring data point examination module assigns weights to neighboring data points of the selected data point based on the neighboring data point's distance from the selected data point. Based on the weight and frame tag of the neighboring data point, a data point correction module makes, a determination whether to change the frame tag of the selected data point. Frame tags corresponding to individual speakers in the audio data then are output from the speaker segmentation and classification system.

The audio processing method includes using a discriminatively-trained classifier as an anchor model, segmenting speakers contained in the audio data into separate classifications by applying the anchor model, and outputting the frame tags. The discriminatively-trained classifier is used to distinguish between speakers in the audio data. Moreover, the discriminatively-trained classifier was trained previously using a training technique. The discriminatively-trained classifier can be a convolutional neural network classifier (such as a time-delay neural network).

### BRIEF DESCRIPTION OF THE DRAWINGS

The present invention can be further understood by reference to the following description and attached drawings that illustrate aspects of the invention. Other features and advantages will be apparent from the following detailed description of the invention, taken in conjunction with the accompanying drawings, which illustrate, by way of example, the principles of the present invention.

Referring now to the drawings in which like reference numbers represent corresponding parts throughout:

FIG. 1 is a block diagram illustrating a general overview of the audio processing system and method disclosed herein.

FIG. 2 illustrates an example of a suitable computing system environment in which the audio processing system and method shown in FIG. 1 may be implemented.

FIG. 3 is a block diagram illustrating the details of an exemplary implementation of the training and validation system shown in FIG. 1.

FIG. 4 is a block diagram illustrating the details of an exemplary implementation of the speaker segmentation and classification system shown in FIG. 1.

FIG. 5 is a block diagram illustrating details of the audio pre-processing module shown in FIGS. 3 and 4.

FIG. 6 is a block diagram illustrating details of the normalization module shown in FIG. 4.

FIG. 7 is a block diagram illustrating details of the temporal sequential smoothing module shown in FIG. 4.

FIG. 8 is a general flow diagram illustrating the operation of the audio processing method disclosed herein.

FIG. 9 is an exemplary embodiment of the audio processing method of the audio processing system shown in FIG. 1.

FIG. 10 is a detailed flow diagram illustrating the operation of the speaker segmentation and classification phase of the audio processing method shown in FIGS. 8 and 9.

FIG. 11 is a detailed flow diagram illustrating the operation of the audio pre-processing method.

FIG. 12 is a detailed flow diagram illustrating the operation of the normalization method.

FIG. 13 is a detailed flow diagram illustrating the operation of the temporal sequential smoothing method.

FIG. 14 is a detailed block diagram illustrating a working example of the audio processing system and method and is presented for illustrative purposes only.

FIG. 15 is a diagram illustrating the K-means clustering technique used in the working example.

### DETAILED DESCRIPTION OF THE INVENTION

In the following description of the invention, reference is made to the accompanying drawings, which form a part thereof, and in which is shown by way of illustration a specific example whereby the invention may be practiced. It is to be understood that other embodiments may be utilized and structural changes may be made without departing from the scope of the present invention.

I. Introduction

The speaker segmentation and classification problem is to attribute and map speech within audio data to individual speakers and to do so accurately and quickly. The audio data typically contains several speakers, but the number and identity of the speakers is usually not known beforehand. Moreover, no training data is available beforehand for the speakers in the audio data. The goal is to segment and classify the speech by individual speaker.

The audio processing system and method disclosed herein uses a discriminatively-trained classifier to distinguish between speakers. This discrimination is based on features. The audio processing system and method generate features by using models of speakers and determining how close the current speaker is to each one of those models. A variety of speakers is used to train the system, and when the system encounters an unknown speaker the system compares the unknown speaker to each of the models. From this comparison, similarities and differences are determined and used to generate feature vectors. The feature vectors are clustered and grouped based on the similarities and differences between models and the unknown speaker.

The audio processing system and method use a discriminatively-trained classifier to determine similarities and differences. In training phase, the discriminatively-trained classifier is trained such that it can distinguish between a speaker and every other speaker in the training set. Rather than saying that a certain speaker is like or more like a model, as for example occurs in GMM training, the discriminatively-trained classifier is trained to say that the certain speaker is not like other speakers. The discriminatively-trained classifier is trained by taking a plurality of speakers and training the classifier to discriminate between the plurality of speakers. In use phase, the audio processing system and method inputs speech from speakers that has never been heard before by the system and clusters the data into as many classifications as needed such that each class corresponds to an individual speaker.

II. General Overview

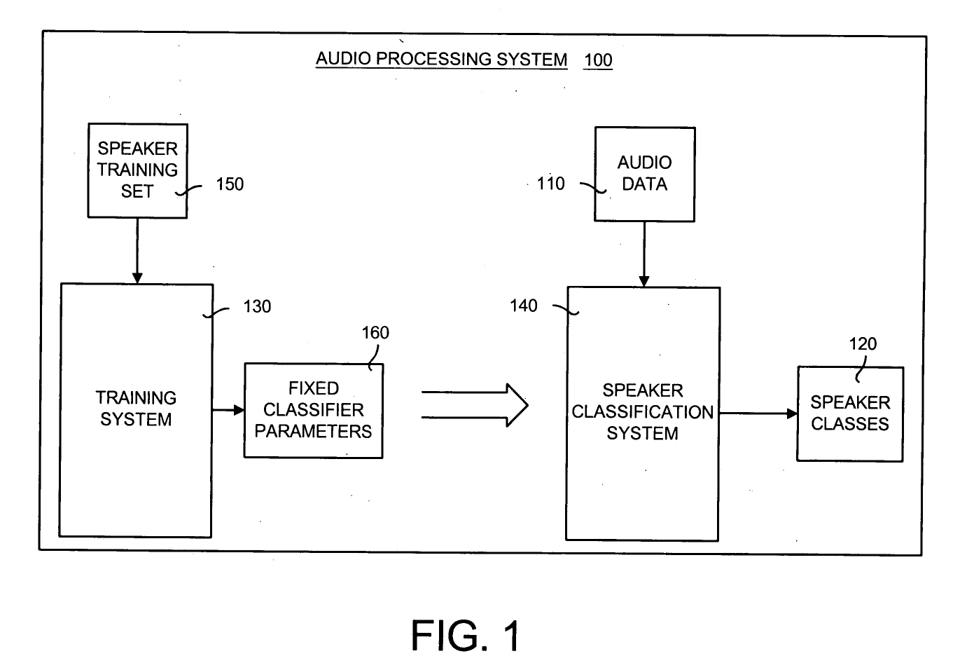

FIG. 1 is a block diagram illustrating a general overview of the audio processing system 100 disclosed herein. In general, the system 100 inputs audio data 110 containing speakers and outputs speaker classes 120 whereby each class represents a speaker in the audio data 110. The audio processing system 100 includes a training system 130 and a speaker classification system 140. The training system 130 trains a discriminatively-trained classifier (such as a time-delay neural network classifier) and the speaker classification system 140 uses the discriminatively-trained classifier to segment and classify speakers within the audio data 110.

The training system 130 and the speaker classification system 140 correspond to the two phases of the audio processing system 100. The first phase is the training phase, where the training system 130 discriminatively trains the discriminatively-trained classifier on a speaker training set 150 containing audio from a known set of speakers. Based on this training, the training system 130 outputs fixed classifier parameters 160. This training phase occurs once to produce the fixed classifier parameters 160. Typically, the fixed classifier parameters 160 corresponds to weights of the discriminatively-trained classifier.

The second phase is the use phase, where the speaker classification system 140 uses the fixed classifier parameters 160 and applies the discriminatively-trained classifier to the audio data 110. The audio data 110 contains a mixture of unknown speakers. Typically, the audio data 110 contains different speakers than the speaker training set 150. The discriminatively-trained classifier operates on the audio data 110 and classifies every frame of speech in the audio data 110 such that all speech corresponding to a single classification comes from a single speaker.

III. Exemplary Operating Environment

The audio processing system and method disclosed herein is designed to operate in a computing environment. The following discussion is intended to provide a brief, general description of a suitable computing environment in which the audio processing system and method may be implemented.

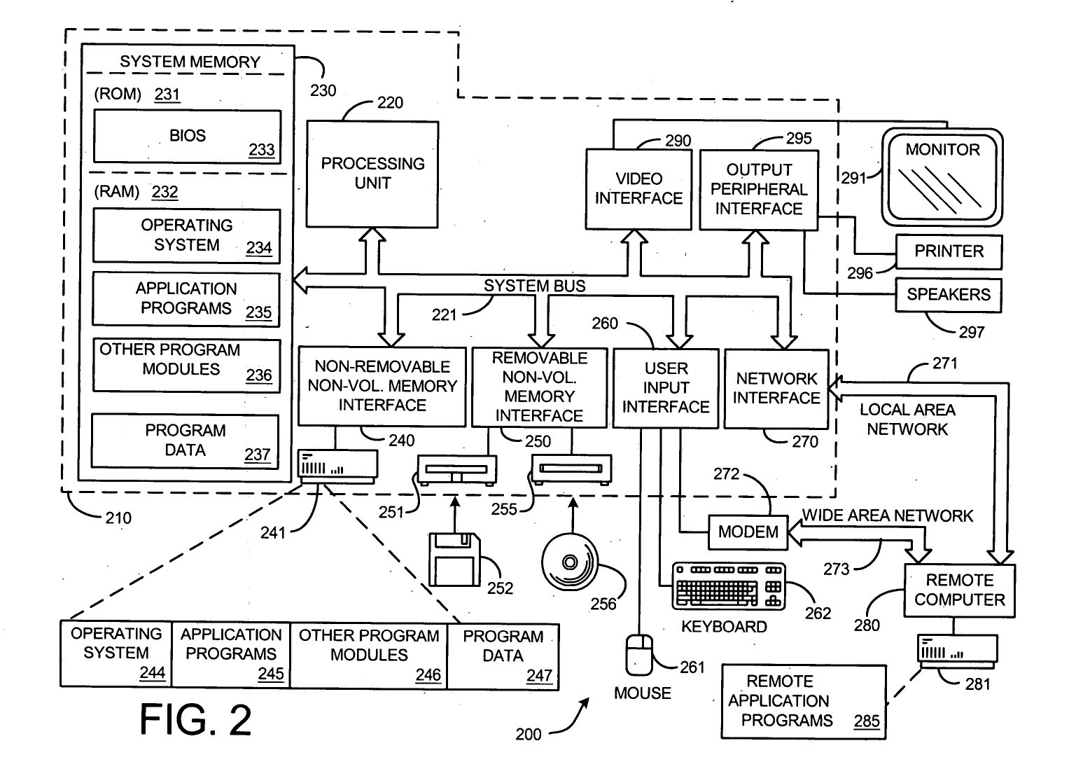

FIG. 2 illustrates an example of a suitable computing system environment 200 in which the audio processing system and method may be implemented. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The audio processing system and method is operational with numerous other general purpose or special purpose computing system environments or configurations. Examples of well known computing systems, environments, and/or configurations that may be suitable for use with the audio processing system and method include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The audio processing system and method may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. With reference to FIG. 2, an exemplary system for implementing the audio processing system and method includes a general-purpose computing device in the form of a computer 210.

Components of the computer 210 may include, but are not limited to, a processing unit 220, a system memory 230, and a system bus 221 that couples various system components including the system memory to the processing unit 220. The system bus 221 may be any of several types of bus structures including a memory-bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 210 typically includes a variety of computer readable media. Computer readable media can be any available media that can be accessed by the computer 210 and includes both volatile and nonvolatile media, removable and non-removable media. By way of example, and not limitation, computer readable media may comprise-computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 210. Communication media typically embodies computer readable instructions, data structures, program modules or other data in a modulated data signal such as a carrier wave or other transport mechanism and includes any information delivery media.

Note that the term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within the computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a keyboard 262 and pointing device 261, commonly referred to as a mouse, trackball or touch pad.

Other input devices (not shown) may include a microphone, joystick, game pad, satellite dish, scanner, radio receiver, or a television or broadcast video receiver, or the like. These and other input devices are often connected to the processing unit 220 through a user input interface 260 that is coupled to the system bus 221, but may be connected by other interface and bus structures, such as, for example, a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

IV. Audio Processing System and Components

As described in general above, the audio processing system 100 includes a training system 130 and a speaker classification system 140. The two systems 130, 140 allow the audio processing system 100 to process audio data and classify the speakers. The training system 130 and a speaker classification system 140 will now be discussed in detail.

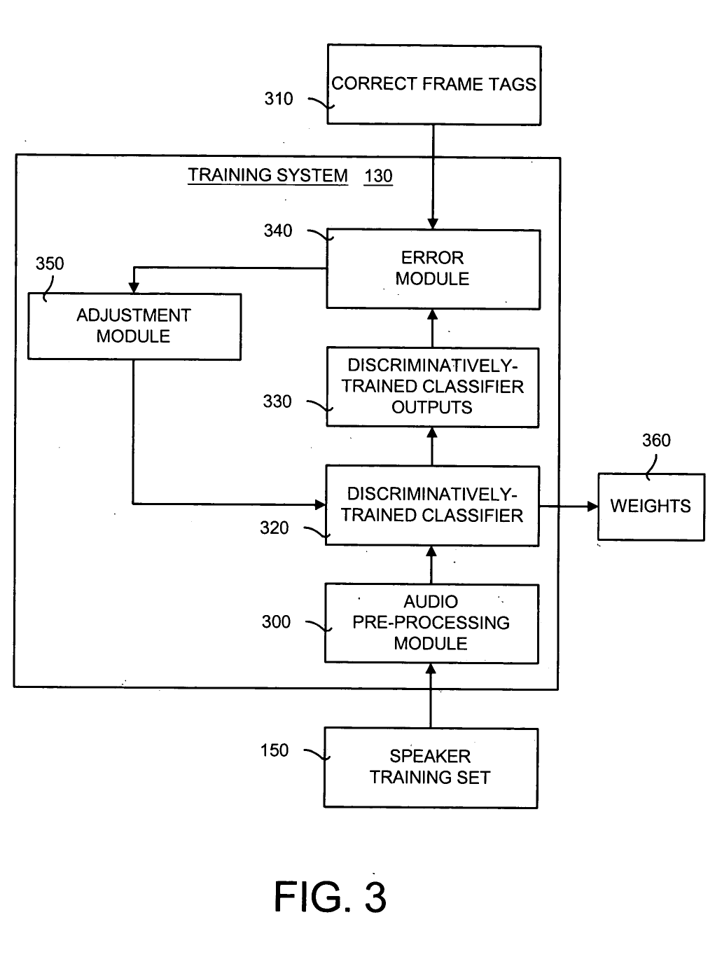

FIG. 3 is a block diagram illustrating the, details of an exemplary implementation of the training system 130 shown in FIG. 1. The training system 130 inputs the speaker training set 150. The speaker training set 150 contains audio captured from a plurality of known speakers. Every time point of the speaker training set 150 is mapped to a speaker or to silence. From this mapping, correct (or true) frame tags 310 are available. An audio pre-processing module 300 is used to pre-process the speaker training set 150 such that the speaker training set 150 is suitable for processing by a discriminatively-trained classifier 320. This pre-processing process is discussed in detail below. The discriminatively-trained classifier 320 includes convolutional neural network classifiers such as time-delay neural network (TDNN) classifiers. Convolutional neural network classifiers and TDNN classifiers are known in the art and are described in section 6.10.4 of “Pattern Classification,” 2^{nd} edition, by R. O. Duda, P. E. Hart, and D. G. Stork, John Wiley & Sons.

For training using the stochastic gradient descent technique, individual elements of the speaker training set 150 are applied to the discriminatively-trained classifier 320 to produce discriminatively-trained classifier outputs 330. Outputs 330 are processed by an error module 340. The error module 340 compares the outputs 330 with the correct frame tags 310 and computes an error metric. Typical error metrics include cross-entropy and mean square error. These error metrics are described in Chapter 6 of “Neural Networks for Pattern Recognition,” by C. M. Bishop, Oxford Press. An adjustment module 350 adjusts the weights of the discriminatively-trained classifier 320 in order to decrease the error metric measured by error module 340.

The discriminatively-trained classifier 320 processes another example from the pre-processed speaker training set 150 using the adjusted weights. Periodically, the classifier 320 is tested on a separate validation set. When the performance on the separate validation set is maximized, the weights 360 are fixed and sent as output from the training system 130. Stopping training when validation performance is maximized is called “early stopping,” and is known in the art. Other techniques of training, such as conjugate gradient descent, are also possible. Training techniques, early stopping, and validation sets all are described in detail in “Neural Networks for Pattern Recognition” cited above.

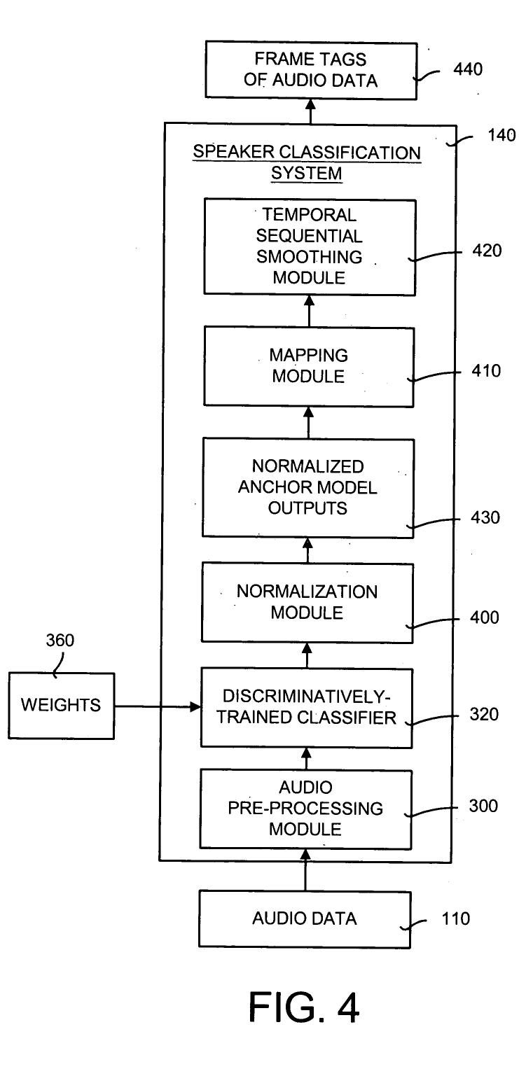

FIG. 4 is a block diagram illustrating the details of an exemplary implementation of the speaker classification system 140 shown in FIG. 1. In general, the speaker classification system 140 accepts audio data 110 containing speech data and outputs labels or classifications for each speaker in the audio data 110. Specifically, in one embodiment the speaker classification system 140 includes the audio pre-processing module 300, the discriminatively-trained classifier 320, a normalization module 400, a mapping module 410, and a temporal sequential smoothing module 420.

The audio data 110 is input to the speaker classification system 140. The audio data 110 is pre-processed using the audio pre-processing module 300. After pre-processing, the audio data 110 is processed by the discriminatively-trained classifier 320 using the weights 360 that were previously determined by the training system 130. The output of the discriminatively-trained classifier 320 is a set of anchor model output vectors. The anchor model output vectors are normalized by the normalization module 400 to produce normalized anchor model output vectors 430. The normalized anchor model output vectors 430 are input to the mapping module 410, which can perform clustering or classification. For speaker identification, module 410 performs classification, while for speaker segmentation, module 410 performs clustering. In either case, module 410 assigns each anchor model output vector to a class. Each class represents an individual speaker in the audio data 110. The temporal sequential smoothing module 420 examines neighboring points of each point to reduce the error rate of the class assignments. The output of the speaker classification system 140 is frame tags of the audio data 440.

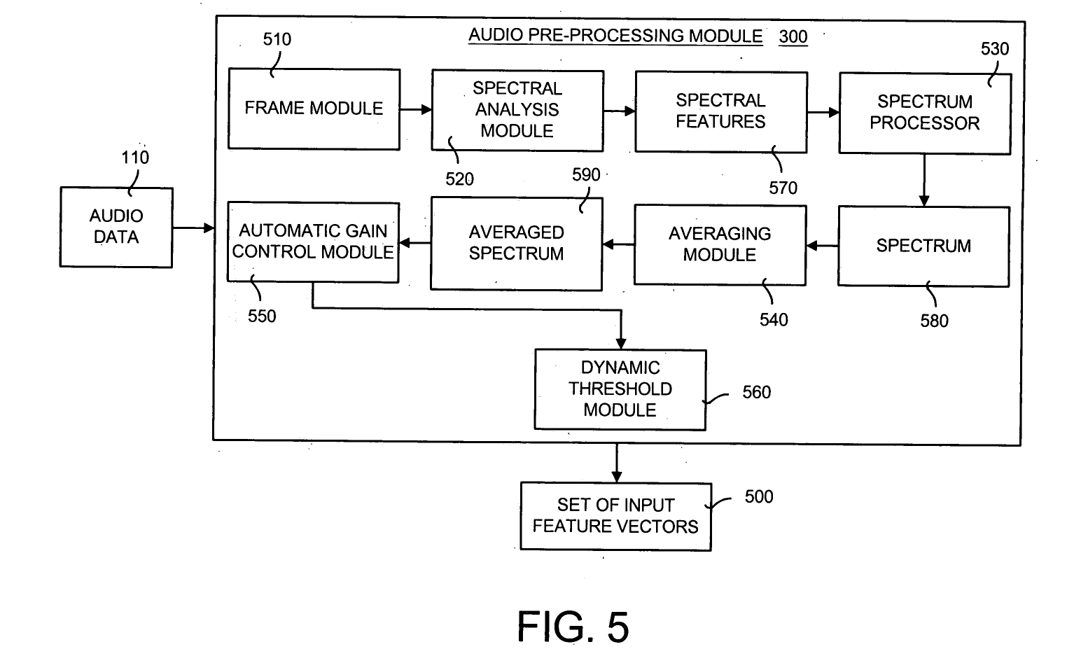

FIG. 5 is a block diagram illustrating details of the audio pre-processing module 300 shown in FIGS. 3 and 4. In general, the audio pre-processing module 300 inputs the audio data 110 and outputs a set of input feature vectors 500. The feature vectors 500 are input for the discriminatively-trained classifier 320. The audio pre-processing module 300 includes a frame module 510, a spectral analysis module 520, a spectrum processor 530, an averaging module 540, an automatic gain control module 550, and a dynamic threshold module 560.

The audio pre-processing module 300 inputs the audio data 110 and the frame module divides the audio data 110 into frames and applies windowing functions to each frame, as is known in the art of spectral analysis. The spectral analysis module 520 performs a spectral analysis (such as a Fourier transform) for each frame to obtain spectral features 570. These spectral features 570 contain both phase and magnitude information. The spectrum processor 530 processes the spectral features 570 such that the phase information is removed, leaving only spectrum 580. Elements of spectrum 580 are averaged by the averaging module 540 to generate averaged spectrum 590. The automatic gain control module 550 applies automatic gain control to the averaged spectrum 590 such that an energy level for each frame is kept smoothly at or near a prescribed level. The dynamic threshold module 560 uses fixed thresholds to set boundaries for the averaged spectrum 590.

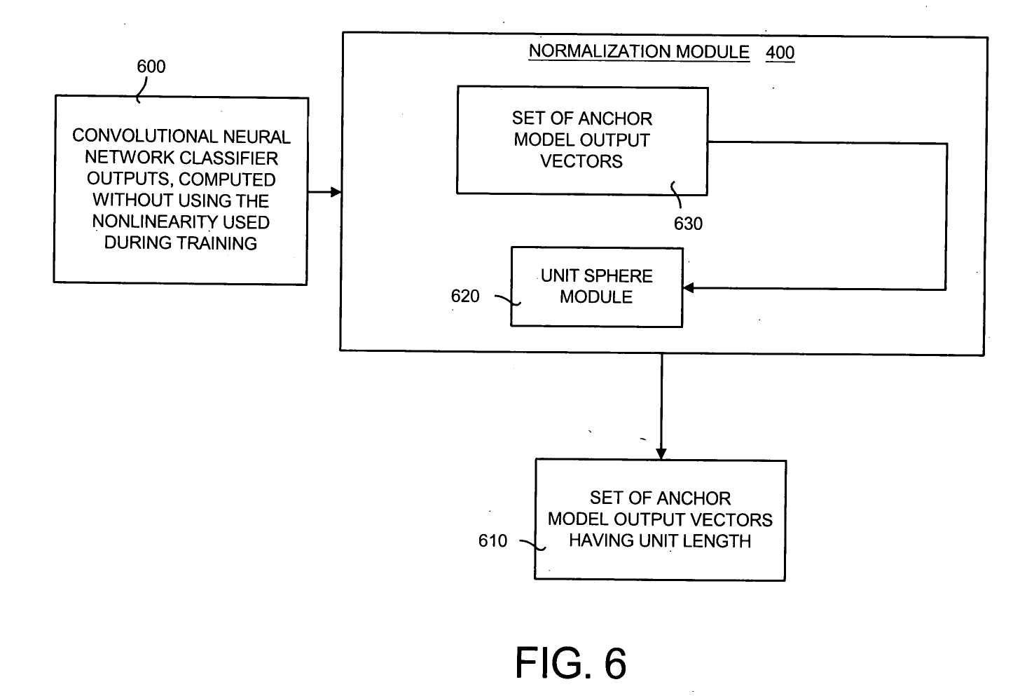

FIG. 6 is a block diagram illustrating details of the normalization module 400 shown in FIG. 4. In general, the normalization module 400 accepts convolutional neural network classifier outputs 600 and produces a set of anchor model output vectors having unit length 610. The convolutional neural network classifiers outputs 600 are generated using a convolutional neural network classifiers, which is an alternate embodiment of the discriminatively-trained classifier 320 shown in FIGS. 3 and 4. The normalization module 400 includes a unit sphere module 620.

The normalization module 400 initially accepts the convolutional neural network outputs 600. These outputs 600 are obtained prior to an application of the final nonlinearity process. In other words, during training, the convolutional neural network uses nonlinearities, but the normalization module 400 obtains the output 600 before the final nonlinearities are applied. The normalization module 400 then produces a set of anchor model output vectors 630 that then are input to the unit sphere module 620. The unit sphere module 620 processes the set of anchor model output vectors 630 such that each anchor model output vector has unit length. This generates the set of anchor model output vectors having unit length 610.

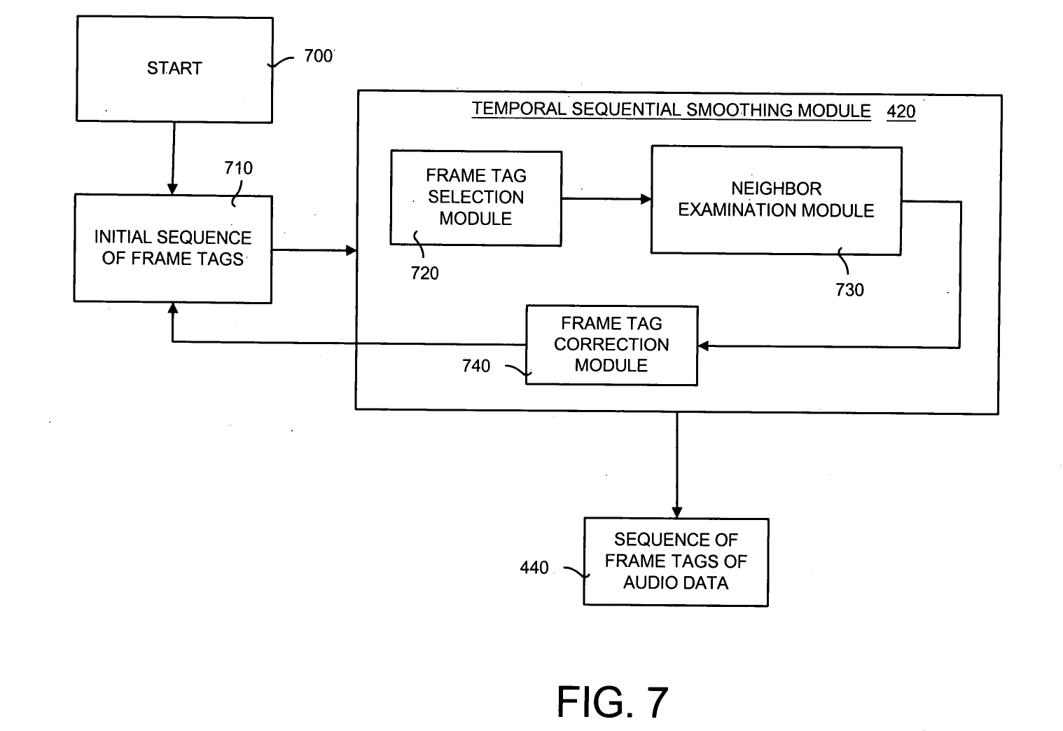

FIG. 7 is a block diagram illustrating details of the temporal sequential smoothing module 420 shown in FIG. 4. In general, the temporal sequential smoothing module 420 starts 700 by accepting an initial sequence of frame tags 710 and produces the sequence of frame tags of the audio data 440. The temporal sequential smoothing module 420 includes a frame tag selection module 720, a neighbor examination module 730, and a frame tag correction module 740.

The temporal sequential smoothing module 420 accepts the initial sequence of frame tags 710 and the frame tag selection module 720 determines the order of the frame tag processing. The neighbor examination module 730 examines neighboring frame tags of the selected frame tag and assigns a weight to each of the neighboring frame tags based on their temporal difference from the selected frame tag. Based on the weights and neighboring frame tags, the frame tag correction module 740 corrects the selected frame tag as necessary.

The mapping of the audio to frame tags generates a sequence of speaker classes, one associated with each input frame. Since the input frames overlap, only the central part (of duration X) of a given frame is assigned a speaker class (the frame tag). Since the step between adjacent frames is also chosen to be X, contiguous frame tags on the output correspond to contiguous audio on the input, even though the tag only identifies the speaker speaking in the central X seconds of the frame. The output frame tags themselves are clustered in time. For example 1112111 would mean three sequential frames are classified as speaker 1, the next frame as speaker 2, and the following three frames as speaker 1 again. Since in one embodiment, the central part of the frame corresponds to only 48 milliseconds of audio (while the frame itself corresponds to approximately 1 second of audio), the shortest such temporal clusters of frame tags are the most likely to be incorrect, and so the temporal sequential smoothing module operates on the shortest temporal frame tag sequences first. Thus the temporal sequential smoothing module 420 shown in FIG. 7 is applied first to temporal clusters of size 1 frame tag, then of size 2 frame tags, and so forth, until the temporal clustering of the entire audio segment no longer changes. In this way, the results of the changes that are most likely to be correct (those correcting the shortest temporal clusters) are incorporated in further temporal cluster error correction for the larger clusters.

V. Operational Overview

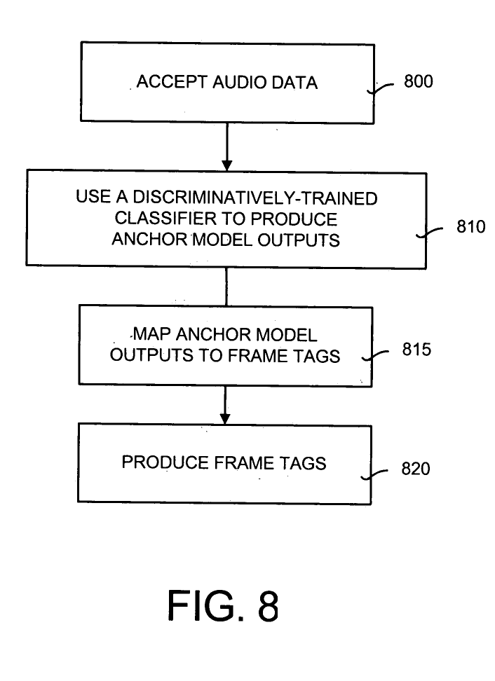

FIG. 8 is a general flow diagram illustrating the operation of the audio processing method disclosed herein. The method begins by accepting audio data (box 800). The audio data typically contains a plurality of registered or unregistered speakers. Next, a discriminatively-trained classifier is used to produce anchor model outputs (box 810). The discriminatively-trained classifier can be a convolutional neural network classifier or a time-delay neural network (TDNN) classifier. The anchor model outputs are mapped to frame tags, one classification for every frame in the audio data (box 815). Finally, the frame tags are produced (box 820). It should be noted that the format of the frame tag output does not need to identify the speaker at every frame. Instead, the speaker classification can be represented by the start and stop times of the audio data where a certain speaker was speaking.

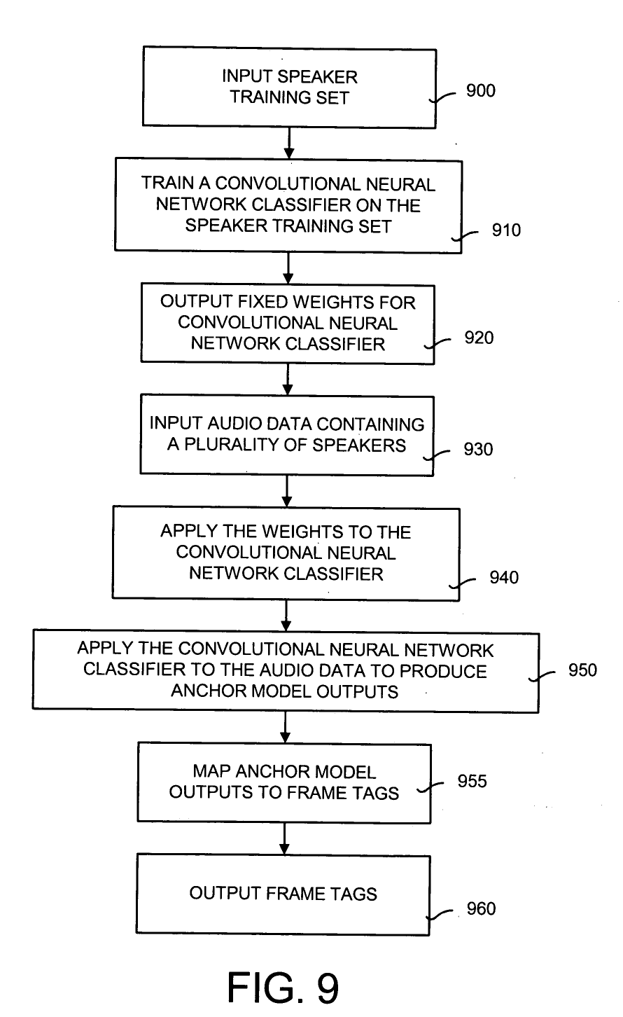

FIG. 9 is an exemplary embodiment of the audio processing method of the audio processing system 100 shown in FIG. 1. The process begins by training a classifier and obtaining weights. In particular, the training phase first inputs a speaker training set (box 900). The speaker training set contains a plurality of speakers whose speaking start and stop times are known. In other words, the speaker training set represents the “true” or ideal data. Next, a convolutional neural network classifier is trained on the speaker training set (box 910). In general, the goal in training the convolutional neural network classifier is to have the frame tags (the output of the classifier) coincide with the speaker training set (the input of the classifier). An iterative process in this training period is performed whereby weights of the convolutional neural network classifier are adjusted and changed until the classifier output is close to the known speaker identity. Once this occurs, the classifier weights are fixed for the convolutional neural network classifier and sent as output (box 920).

The second phase (or use phase) of the audio processing method is to segment and classify unknown speakers. This phase begins by accepting audio data containing a plurality of speakers (box 930). For speaker segmentation, the speakers in the audio data are unregistered. Next, the weights obtained during the training phase are applied and used by the convolutional neural network classifier (box 940). Using these weights, the classifier is applied to the audio data to produce anchor model outputs corresponding to frames in the audio data (box 950). These anchor model outputs are mapped to frame tags (box 955), either using clustering (for speaker segmentation) or using a classification algorithm (for speaker identification). Each of the frame tags then is output (box 960).

VI. Operational Details

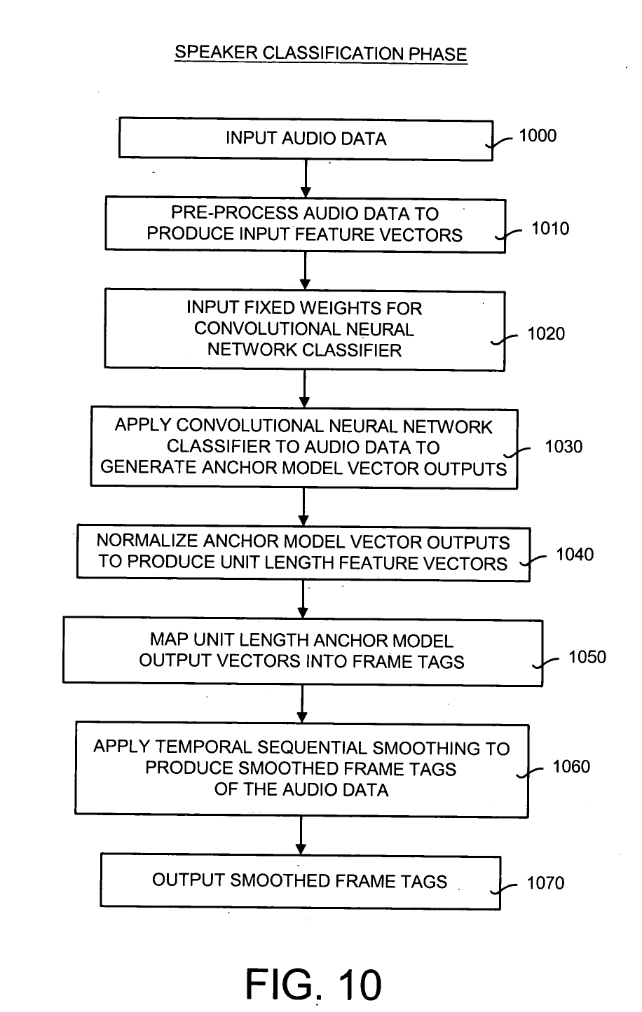

FIG. 10 is a detailed flow diagram illustrating the operation of the speaker classification phase of the audio processing method shown in FIGS. 8 and 9. In general, the speaker classification phase uses the fixed weights obtained from the training phase and applies a discriminatively-trained classifier using the weights to audio data. In particular, as shown in FIG. 10, the speaker classification phase begins by inputting audio data (box 1000). Typically, the, audio data contains a plurality of speakers who start and stop times of speaking in the audio data are not known. In addition, the speakers may or may not have undergone a registration process.

The audio data then is pre-processed to produce a set of input feature vectors for the classifier (box 1010). It should be noted that the audio data is pre-processed in the same manner as the speaker training set in the training phase. This ensures that the classifier sees the same type of input feature vectors on which it was trained. Next, the fixed weights for the convolutional neural network classifier and obtained from the training phase are input (box 1020). The convolutional neural network classifier is applied to the audio data to generate anchor model output vectors (box 1030). The anchor model output vectors are normalized (as described in detail below) to generate anchor model output vectors having unit length (box 1040).

Each of the unit length anchor model output vectors is mapped into a frame tag (box 1050). This mapping can be performed using either a clustering algorithm or a classification algorithm. Temporal sequential smoothing, which is described in detail below, is applied to the initial frame tags to produce final (or smoothed) frame tags of the audio data (box 1060). The smoothed frame tags then are output (box 1070).

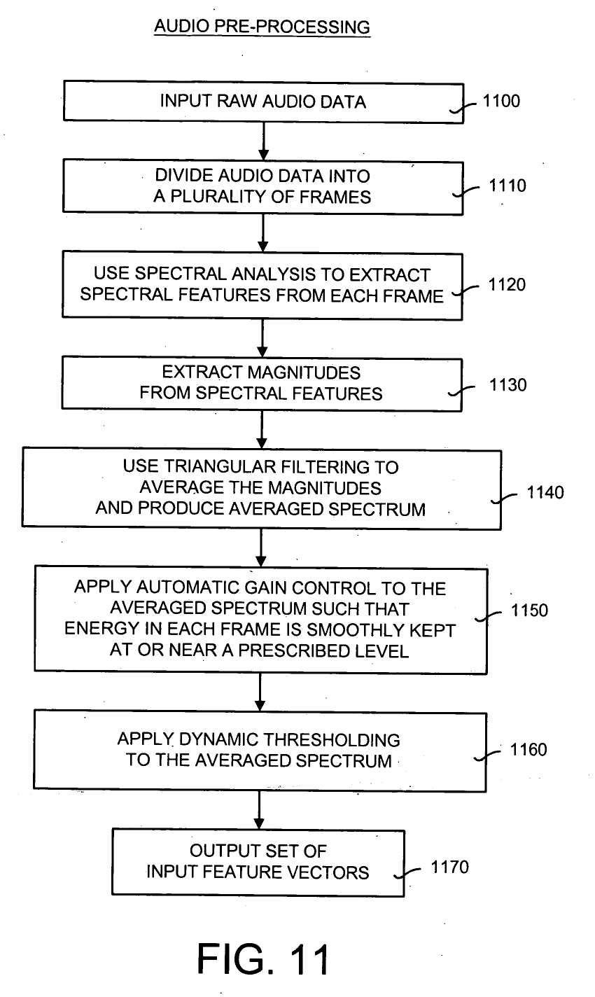

FIG. 11 is a detailed flow diagram illustrating the operation of the audio pre-processing method. The audio pre-processing method is used in both the training phase and in the speaker classification phase. This is done so that the discriminatively-trained classifier sees generally the same input in both phases.

Referring to FIG. 11, the audio pre-processing method begins by inputting raw audio data (box 1100). The raw audio data is divided into a plurality of frames, which are windowed with windowing functions (box 1110). Next, using spectral analysis, spectral features are extracted from each of the frames (box 1120). The extracted spectral features contain both magnitude and phase information. The magnitudes are extracted from each of the spectral features and the phase information is discarded (box 1130). Triangle filtering then is used to average each resulting spectrum and produce averaged spectra (box 1140).

Automatic gain control is applied to the averaged spectra to ensure that the energy in each frame is smoothly kept at or near a prescribed level (box 1150). Next, dynamic thresholding is applied (box 1160). Finally, a set of input feature vectors is output (box 1170).

In the dynamic thresholding, the spectral output for a given triangular filter is scaled by the Automatic Gain Control factor, a fixed, small offset is added, and the log is taken. If this log power falls below a particular threshold T (computed for that particular triangular filter using a fixed set of training data, and offset by a fixed amount), then the output is set to zero. Otherwise, if this log power has not been set to zero, it is set to the difference between its value and the value of the threshold T. This ensures that the feature vector is independent of the amplitude or the scale of the input audio. that very low energy features are discarded, and that the value 0 corresponds to no power.

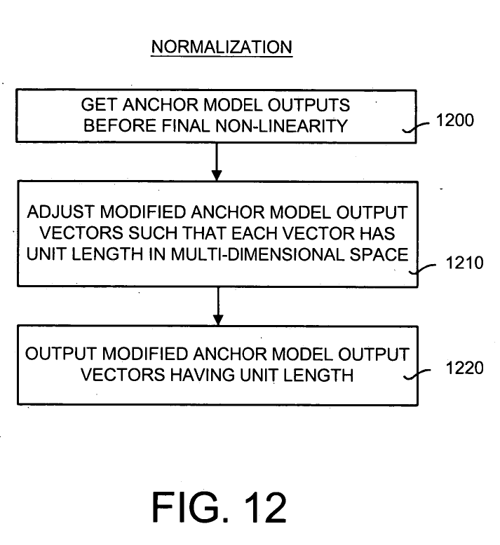

FIG. 12 is a detailed flow diagram illustrating the operation of the normalization method. The normalization process is used to remove spurious discrepancies caused by scaling by mapping data to a unit sphere. In particular, the normalization process begins by accepting anchor model outputs before the final non-linearity of the convolutional neural network (box 1300). Each frame of audio data thus produces a modified anchor model output vector. These modified anchor model output vectors then are adjusted such that each vector has unit length (box 1210). The unit-length modified anchor model output vectors then are produced (box 1220).

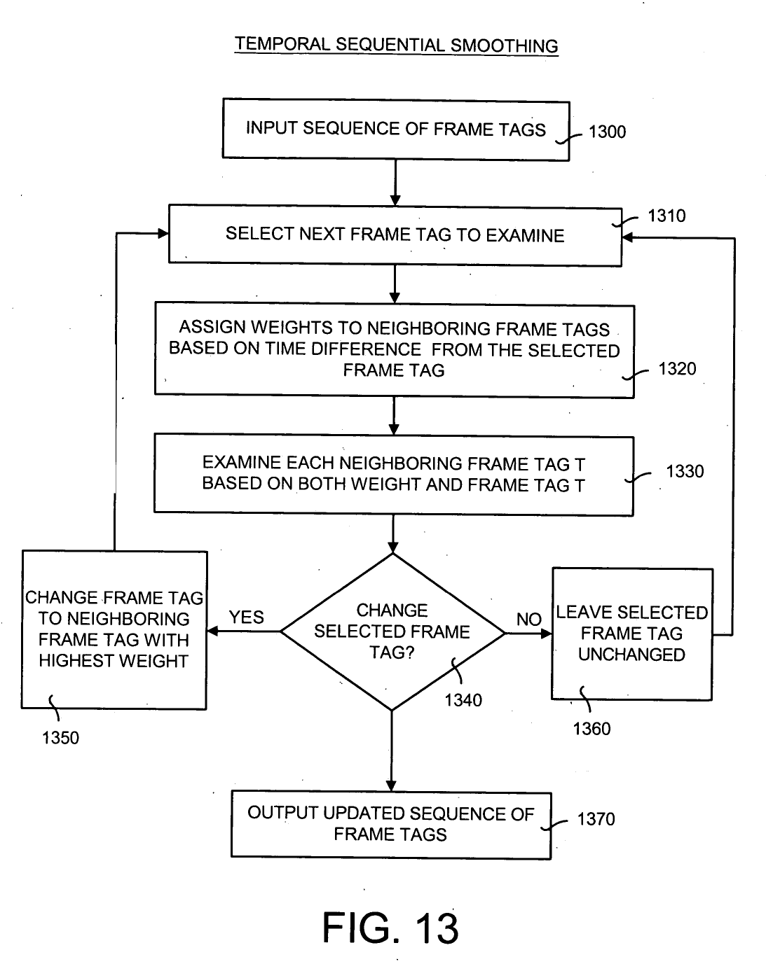

FIG. 13 is a detailed flow diagram illustrating the operation of the temporal sequential smoothing method. Generally, the temporal sequential smoothing method takes advantage of the fact that a speaker is very unlikely to speak for only a very short time (for example, 48 milliseconds). This temporal information is used to reduce the error rate of frame tags.

Referring to FIG. 13, the temporal sequential smoothing method begins by inputting a sequence of frame tags (box 1300). A frame tag is selected for examination (box 1310). In general, frame tags corresponding to a given speaker speaking contiguously for the shortest duration are selected first, while frame tags corresponding to a given speaker speaking contiguously for longer durations are selected for later processing. Next, weights are assigned to neighbors of the selected frame tags based on the temporal distance from the selected frame tag (box 1320). Each neighboring frame tag is examined based on its weight and classification (box 1330).

A determination then is made as to whether the classification of the selected frame tag should be changed based on the weight and classification of the neighboring frame tags (box 1340). If it is determined that the classification of the selected frame tag should be changed, then the change is made (box 1350). Other frame tags then are selected using the changed classification of the selected frame tag. If it is determined that no change is necessary, then the classification of the selected frame tag is left unchanged (box 1360). Other frame tags are then selected and processed using the unchanged classification of the selected frame tag. The output is the sequence of updated frame tags (box 1370). For example, a sequence of frame tags that are input to FIG. 13 might be represented by 1112111, where speaker 1 is speaking at frames 1, 2 and 3, where speaker 2 is speaking at frame 4, and where speaker 1 is again speaking at frames 5, 6 and 7. Since in this example, there is a sequence of frame tags of only one element (corresponding to speaker 2 at frame 4), and since that frame tag is surrounded by frame tags of a single, different class (speaker 1), the temporal sequential smoothing module will replace this sequence with 1111111.

VII. Working Example

In order to more fully understand the audio processing system and method disclosed herein, the operational details of an exemplary working example are presented. It should be noted that this working example is only one way in which the audio processing system and method may be implemented.

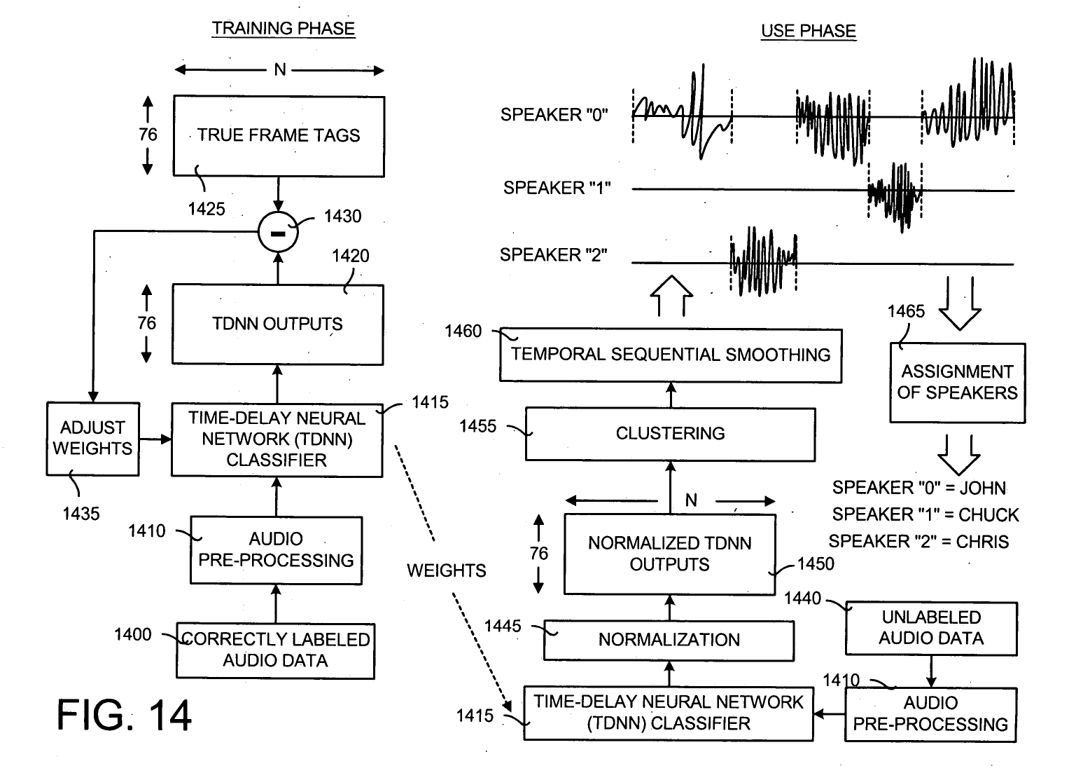

FIG. 14 is a detailed block diagram illustrating a working example of the audio processing system and method and is presented for illustrative purposes only. In this working example, there are two phases. The first phase involves the training of a time-delay neural network (TDNN) classifier on audio from a set of known speakers. This is performed once, and then the TDNN is fixed. The second phase is the speaker classification (or use) phase. In the use phase, the TDNN is applied to new audio data from a mixture of new speakers. The TDNN then operates on the new audio data and labels every frame of speech in the new audio data such that all speech corresponding to a single label comes from a single speaker.

### Training Phase

The general idea of the training phase is to take audio data containing a set of speakers and train a TDNN classifier to be as discriminative as possible between those speakers. This discriminative training allows the TDNN classifier outputs to be used to help classify other unknown speakers during the use phase. The training phase uses the training data to train the TDNN classifier and obtain the best possible parameters for the TDNN classifier such that it is as discriminative as possible between the speakers. Diversity of training data is key in this working example. A total of 76 speakers are used, with 38 being male voice and 38 being female voices. The speakers were chosen to span the range of accents.

Audio Pre-Processing

In both the training and the use phases, raw audio is pre-processed in the same manner before being fed into the TDNN. This description of the pre-processing deals with the pre-processing during the training phase. However, it should be noted that the pre-processing during the use phase is identical, except that the pre-processing is performed on different audio data.

In the training phase, audio data containing correctly labeled audio data 1400 is used. In other words, it is known who is speaking and when they are speaking, such that the start and stop times of speakers in the audio data are known. The correctly labeled audio data then is processed by the audio pre-processing 1410. During audio pre-processing 1410, the correctly labeled audio data 1400 (or raw audio data) are divided into frames of 32 millisecond duration with an overlap of 16 milliseconds. In other words, frames are being generated every 16 milliseconds. It should be noted that a frame is a portion of the raw audio data, and that the frame described here has much smaller duration than the frames used to describe the full field of view of the neural network. This frame size is used because it roughly the time scale of individual phonemes. A spectral analysis then is performed for each frame, to extract audio features from each frame. In this working example, a modulated complex lapped transform (MCLT) is applied to each frame so as to extract audio features from each window. Each frame has an associated spectogram containing 256 spectral magnitudes. It should be noted that the corresponding frequencies depend on the sampling rate used. In this working example a sampling rate of 16 KHz is used, giving a maximum measured frequency of 8 KHz.

The MCLT is generally a time-frequency map containing complex numbers. The complex-numbers contain both a magnitude and phase information. The phase information is discarded. Mel-based triangle filtering is performed on the magnitudes, as is known in the art of speech recognition. This leaves 40 values of the resulting averaged magnitudes.

Automatic gain control (AGC) then is applied to these 40 values in such a way that the energy in each frame is smoothly kept close to a prescribed level. AGC decides at any given time what the average signal power was over the last few frames. The AGC has two main characteristics. First, the AGC has a growth rate when the signal power is lower than a desired signal power. In this case, the AGC raises the power level slowly according to the growth rate. If the signal power is much higher than the desired power level, the AGC lowers the power level much more quickly (as compared to raising the power level) to the desired power level. In other words, the AGC attempts to keep the energy (or power level or volume) relatively constant.

The maintenance of the energy at the same power lever by the automatic gain control allows the use of a fixed threshold for each of the 40 resulting magnitude values. In the dynamic thresholding, the spectral output for a given triangular filter is scaled by the Automatic Gain Control factor, a fixed, small offset is added, and the log is taken. If this log power falls below a particular threshold T (computed for that particular triangular filter using a fixed set of training data, and offset by a fixed amount), the output is set to zero. Otherwise, if this log power has not been set to zero, it is set to the difference between its value and the value of the threshold T. This ensures that the feature vector is independent of the amplitude or the scale of the input audio. that very low energy features are discarded, and that the value 0 corresponds to no power. Finally, a set of input feature vectors is output. These input feature vectors, each of which corresponds to 32 milliseconds in time, are concatenated over time into a matrix of 40×N elements, where N is determined by the duration of the audio.

Training the TDNN

The input feature vectors of the pre-processed audio data then are sent to a time-delay neural network (TDNN) classifier 1415. It should be noted that the TDNN classifier 1415 is a specific type of convolutional neural network (CNN) classifier. A CNN classifier includes one or more layers. In this working example, each of the layers includes a convolution of a multi-dimensional signal followed by a non-linearity. In general, a CNN classifier has two main advantages. First, the CNN classifier can handle arbitrary sized inputs. This can be useful in speaker classification, since in general the speaker inputs vary in duration from one training set to the next, and vary similarly in use phase. Second, the use of convolutional kernels controls the capacity of the network to prevent overfitting, which is known in the art to improve classification performance

The TDNN classifier 1415 is a specific type of CNN classifier whereby each layer performs one-dimensional convolutions in time. In this working example, the TDNN classifier 1415 has two layers with each layer including a one-dimensional convolution followed by a nonlinearity. For every input frame, the TDNN classifier 1415 has S outputs, where S is the number of speakers used during the training phase. For training, audio data from each of the S speakers is used (along with extra examples with added noise), and the TDNN classifier 1415 is trained to discriminate between them.

In this working example, a 7×40 kernel is used as the convolution for the TDNN classifier 1415. The convolution is evaluated every 3 frames (or every 48 milliseconds). Fifty (50) different kernels are evaluated, with each of the evaluations of the kernel yielding a single horizontal line or strip. This yields 50 strips that are lined up next to each other. The next layer takes 50×20 frames and produces a single number. This is done 76 different times corresponding to 76 different speaker classes. Thus, the input is 40×N feature vectors and the TDNN output 1520 is approximately 76×(N/3) anchor model outputs. Note that an obvious and simple generalization of this approach would be to add an extra output unit that identifies when the input is speech and when it is not speech, so that only output data generated by speech is clustered.

In this working example, two techniques are used to train the TDNN classifier 1415. In a first embodiment, the training includes minimizing the well-known cross-entropy error metric. For every training example, the weights of both layers of the TDNN classifier 1415 are adjusted to decrease the cross-entropy error metric. In an alternate embodiment, training the TDNN classifier 1415 includes minimizing the mean-squared error metric. In this alternate embodiment, the output layer of the TDNN has no non-linearity. In other words, the alternate embodiment had the TDNN perform regression, rather than classification. Note that in this embodiment, a frame tag corresponds to an input frame for the TDNN, which comprises features from approximately 1 second of audio, as opposed to the original frames used in audio preprocessing, which were 32 ms long.

For every training example, the TDNN outputs 1420 are compared to true frame tags 1425. If there is a difference between the TDNN outputs 1420 and the “truth” (i.e., the true frame tags 1425), the difference 1430 is computed. The weights 1435 are adjusted slightly, which tends to improve the output of the TDNN so that the output gets closer to those corresponding to the true frame tags. In this working example, the newly adjusted weights then are used by the TDNN classifier 1415 to process other input feature vectors. The iterative procedure of evaluation and adjusting continues. Periodically, the performance of the TDNN on a validation set (separate from the training set) is evaluated. When the performance of the TDNN on the validation set reaches a maximum, training is halted. The weights then are fixed for use by the TDNN classifier during the use phase.

### Use Phase

The audio data used in the use phase is unlabeled audio data 1440. Typically, the unlabeled audio data 1440 contains different speakers than used in the training phase. However, it should be noted that it is not a requirement that the speakers be different. It is desirable that the incoming audio signal during the use phase be as close as possible to what the TDNN classifier saw during the training phase (even if the speakers are different), because the TDNN classifier was trained on that type of signal. Thus, the same audio pre-processing 1410 is performed in the use phase as is performed in the training phase.

Normalization

Input feature vectors from the audio pre-processing 1415 is fed into the TDNN classifier 1415. Next, the TDNN outputs are normalized 1445 to produce normalized TDNN outputs 1450. Normalization 1445 includes omitting the nonlinearity contained in the second layer of the TDNN classifier 1415 (in this case the TDNN classifier was trained using the cross-entropy technique). In other words, the numbers before the nonlinearity are used (there were 76 of these numbers). Next, the 76 values are normalized such that the 76-dimensional feature vectors contained in the normalized TDNN outputs 1450 has unit length in 76-dimensional space. In effect, normalization maps the output feature vectors to a unit sphere in order to remove spurious scale dependencies. This creates a new feature vector of unit length, or the normalized TDNN outputs 1450.

Clustering

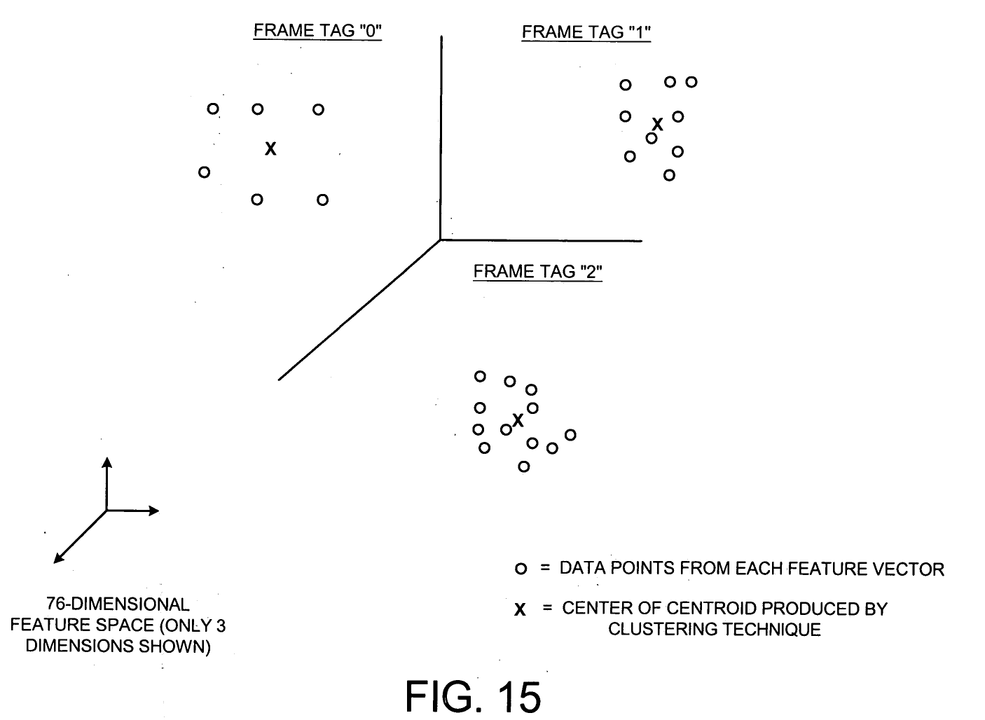

To perform speaker segmentation, the normalized TDNN outputs 1450 then are clustered 1455 in order to assign a speaker tag to every frame. In one embodiment, each of the feature vectors in the normalized TDNN outputs 1450 are clustered using the well-known K-means clustering technique. FIG. 15 is a diagram illustrating the K-means clustering technique used in this working example. This technique uses the squared Euclidean distance to find which cluster a point belongs and to find the center of the cluster. As shown in FIG. 15, the clustering technique found three frame tags, namely frame tag “0”, frame tag “1” and frame tag “2”. Each of the circles represents a data point (or element) from a feature vector. The “X”s represent the center of the centroid produced by the clustering technique for each of the classes.

In an alternate embodiment, a Gaussian Mixture Model is added to the clustering technique to improve the clustering and provide output probabilities. Whichever clustering embodiment is used, the output of the clustering 1455 is that every frame of audio data is assigned a frame tag (e.g., “0”, “1” or “2”). The speech assigned to one frame tag is assumed to be generated from one speaker.

In another alternate embodiment for speaker identification, the clustering 1455 is replaced by classification. When the speakers are registered, a diagonal Gaussian in normalized anchor model space is estimated for each speaker. Thereafter, a normalized anchor output vector is classified according to which Gaussian is most likely to have generated the vector. These Gaussians can be updated using on-line algorithms, as is known in the art.

In yet another alternate embodiment for speaker clustering, the TDNN can be trained such that non-speech is assigned a ‘none-of-the-above’ class. In this embodiment, rather than having an extra output unit on the TDNN to represent non-speech, the outputs are all set to a fixed value far from all other target values, so that non-speech frames will also cluster into a ‘non-speech’ cluster. Since the TDNN target outputs for non-speech are chosen, there is then no difficulty in identifying the cluster as being generated by non-speech.

Temporal Sequential Smoothing

Temporal sequential smoothing 1460 is used to improve the performance of the speaker classification. It should be noted that thus far the clustering (or classification) 1455 has not incorporated or make use of any temporal sequence information from the original audio data 1440. In this working example, the audio data is divided into a sequence of preprocessed frames, where each frame corresponds to 1.024 seconds of audio, and the steps between the frames corresponds to 48 milliseconds. The clustering 1455 operates on this framed data, and the temporal sequential smoothing 1460 is Used to take advantage of the fact that the frames are known to originate from sequential data. For example, it is highly unlikely that the central 48 milliseconds from a single frame is from one speaker while all the surrounding frames are tagged as being from another speaker. In that case, the per-frame error rate can be significantly reduced by relabeling that single frame to the label of its neighbor.

In this working example, the temporal sequential smoothing 1460 is used to select a frame tag. Sequences of identical frame tag with shortest duration are selected first and then changed, and then progressively longer duration sequences of identical frame tag are examined. Each neighboring frame tag of the selected frame tag sequence is examined to determine to which class the point belongs (i.e., class “0”, “1” or “2”). Next, each of the neighboring points is assigned a weight that decreases as the distance from the selected point increases. Based on weight and the value of the neighboring points, it is determined whether to change the value of the selected data point. This can be done, for example, by using a Gaussian, or other probability density function for the weighting function, in which case the combined and suitably normalized weights at the selected tag location can be interpreted as probabilities that the tag should have a particular value. Selected points having shorter duration are changed first, thus having an effect on the points of longer duration. This sets forth a cascading effect of correcting any errors in the frame tags, in such a way that the highest confidence changes are made first, and then are acted upon in subsequent frame tag changes. The temporal sequential smoothing reduces the error rate and increases accuracy of the frame tags by a factor of between 2 and 3.

The output of the use phase is a speech assignment that corresponds to every label that can be presented to a user. As shown in FIG. 14, this is shown graphically by the lines labeled “speaker “0”, speaker “1” and speaker “2”. Every piece of audio that is clustered has a time stamp so that the location of the speech in the audio data could be recovered. In other words, audio pieces at different locations in the audio data can be clustered together without any loss of information about where each audio clip is located in the audio data. Referring to FIGS. 1 and 15, the top line of clustered audio data labeled speaker “0” is speech that clustered near the class “0” centroid, the middle line of clustered audio data labeled speaker “1” is speech that clustered near the class “1” centroid, and the bottom line of clustered audio data labeled speaker “2” is speech that clustered near the class “2” centroid. It should be noted that straight lines indicate silence.

For the speaker segmentation embodiment, a user then assigns 1465 a label and identity to each of the speakers such that any further processing (such as searching or indexing) could use the names of the speakers. The user accomplishes this by listening to a few seconds of audio from each of the classes, determining the identity of the speaker, and then assigning a label. As long as the user knows the identity of the speakers, it typically only takes a few seconds of audio for the user to identify each speaker. As shown in FIG. 14, in this case speaker (or class) “0” was John, speaker “1” was Chuck, and speaker “2” was Chris. Thus, with very little manual labor, the user is able to identify and label the speakers. There may be many-to-one assignments of labels to speakers, as long as each label corresponds to a single speaker. For example, a particular speaker may be assigned labels 2 and 3, because his speech naturally clusters into two separate clusters. As the number of clusters increases, the accuracy of assignment of frames to speaker increases, at the cost of more user work in assigning labels to speakers.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description of the invention, but rather by the claims appended hereto.

What is claimed is:

1. A method for processing audio data, comprising:
applying a plurality of anchor models to the audio data;
mapping the output of the plurality of anchor models into frame tags; and
producing the frame tags;
wherein the plurality of anchor models comprise a discriminatively-trained classifier.

2. The method as set forth in claim 1, wherein the discriminatively-trained classifier comprises a convolutional neural network classifier.

3. The method as set forth in claim 2, further comprising training the convolutional classifier on data separate from audio data available in a use phase.

4. The method as set forth in claim 2, wherein the convolutional neural network classifier is a time-delay neural network (TDNN) classifier.

5. The method as set forth in claim 4, further comprising training the TDNN classifier using cross entropy.

6. The method as set forth in claim 1, further comprising pre-processing the audio data to generate input feature vectors for the discriminatively-trained classifier.

7. The method as set forth in claim 1, further comprising normalizing a feature vector output of the discriminatively-trained classifier.

8. The method as set forth in claim 7, wherein the normalized feature vectors are vectors of unit length.

9. The method as set forth in claim 1, further comprising:
accepting a plurality of input feature vectors corresponding to audio features contained in the audio data; and
applying the discriminatively-trained classifier to the plurality of input feature vectors to produce a plurality of anchor model outputs.

10. The method as set forth in claim 1, wherein the mapping comprises:
clustering anchor model outputs from the discriminatively-trained classifier into separate clusters using a clustering technique; and
associating a frame tag to each separate cluster.

11. The method as set forth in claim 10, further comprising applying temporal sequential smoothing to the frame tag using temporal information associated with the anchor model outputs.

12. The method as set forth in claim 1, further comprising:
training the discriminatively-trained classifier using a speaker training set containing a plurality of known speakers; and
pre-processing the speaker training set and the audio data in the same manner to provide a consistent input to the discriminatively-trained classifier.

13. A computer-readable medium having computer-executable instructions for performing the method recited in claim 1.

14. A computer-implemented process for processing audio data, comprising:
applying a plurality of anchor models to the audio data;
mapping the output of the anchor models into frame tags; and
producing the frame tags;
wherein the plurality of anchor models comprise a discriminatively-trained classifier that is previously trained using a training technique.

15. The computer-implemented process of claim 14, wherein the training technique employs a cross-entropy cost function.

16. The computer-implemented process of claim 14, wherein the training technique employs a mean-square error metric.

17. The computer-implemented process of claim 14, wherein the discriminatively-trained classifier comprises a convolutional neural network classifier.

18. The computer-implemented process of claim 14, further comprising:
omitting an output non-linearity, which was used during training, from the discriminatively-trained classifier to generate a modified feature vector output; and
normalizing the modified feature vector output.

19. The computer-implemented process of claim 18, wherein normalizing further comprises creating a modified feature vector output having unit length.

20. A method for processing audio data containing a plurality of speakers, comprising:
applying a plurality of anchor models to the audio data;
mapping an output of the anchor models into frame tags; and
constructing a list of start and stop times for each of the plurality of speakers based on the frame tags;
wherein the plurality of anchor models comprise a discriminatively-trained classifier previously trained using a training set containing a set of training speakers, and wherein the plurality of speakers is not in the set of training speakers.

21. The method as set forth in claim 20, wherein the discriminatively trained classifier is a time-delay neural network (TDNN) classifier.

22. The method as set forth in claim 20, further comprising normalizing a feature vector output from the convolutional neural network classifier by mapping each element of the feature vector output to a unit sphere such that the feature vector output has unit length.

23. One or more computer-readable media having computer-readable instructions thereon which, when executed by one or more processors, cause the one or more processors to implement the method of claim 20.

24. A computer-readable medium having computer-executable instructions for processing audio data, comprising:
training a discriminatively-trained classifier in a discriminative manner during a training phase to generate parameters that can be used at a later time by the discriminatively-trained classifier;
applying the discriminatively-trained classifier that uses the parameters to the audio data to generate anchor model outputs; and
clustering the anchor model outputs into frame tags of speakers that are contained in the audio data.

25. The computer-readable medium of claim 24, further comprising pre-processing a speaker training set during the training and validation phase to produce a first set of input feature vectors for the discriminatively-trained classifier.

26. The computer-readable medium of claim 25, further comprising pre-processing the audio data during the use phase to produce a second set of input feature vectors for the discriminatively-trained classifier, the pre-processing of the audio data being preformed in the same manner as the pre-processing of the speaker training set.

27. The computer-readable medium of claim 24, further comprising normalizing the feature vector outputs to produce feature vectors having a unit length.

28. The computer-readable medium of claim 27, wherein normalizing further comprises omitting a nonlinearity from the discriminatively-trained classifier during the use phase.

29. The computer-readable medium of claim 25, further comprising applying temporal sequential smoothing to the clustering the clustered feature vector outputs to produce the frame tags.

30. A computer-implemented audio processing process for segmenting and classifying speakers within audio data, comprising:
dividing the audio data into a plurality of frames;
using spectral analysis to extract feature vectors from each of the plurality of frames;
outputting a set of input feature vectors containing the extracted feature vectors;
applying a time-delay neural network (TDNN) classifier to the input feature vectors to produce anchor model outputs, the TDNN classifier having been trained previously using a training technique and a speaker training set containing known speakers; and
generating frame tags from the anchor model outputs, such that each frame tag corresponds to a single one of the speakers.

31. The computer-implemented audio processing process as set forth in claim 30, further comprising extracting magnitudes from the feature vectors.

32. The computer-implemented audio processing process as set forth in claim 30, further comprising using Mel warped triangular filtering to average feature vector magnitudes and produce averaged feature vectors.

33. The computer-implemented audio processing process as set forth in claim 32, further comprising applying automatic gain control to the averaged feature vectors such that energy in each frame is smoothly kept at approximately a constant level.

34. The computer-implemented audio processing process as set forth in claim 32, further comprising applying dynamic thresholding to the averaged feature vectors to generate upper and lower energy boundaries.

35. The computer-implemented audio processing process as set forth in claim 30, wherein each of the plurality of frames has a duration of greater than 20 milliseconds.

36. A method for segmenting and classifying a plurality of speakers contained within audio data, comprising:
pre-processing the audio data by dividing the audio data into a plurality of frames having a duration of approximately 32 milliseconds;
using spectral analysis to extract feature vectors from each of the plurality of frames;
applying a time-delay neural network (TDNN) classifier to the feature vectors to produce anchor model outputs; and
extracting numbers from the TDNN classifier before the nonlinearity used in the training phase, to produce modified anchor model output vectors from the anchor model outputs.

37. The method of claim 36, further comprising adjusting the modified anchor model output vector such that each modified anchor model output vector has unit length in multi-dimensional space.

38. The method of claim 36, further comprises mapping the elements of the modified anchor model output vector to a unit sphere.

39. A method for processing audio data containing unknown speakers to segment and classify the speakers into separate and distinct classes, comprising:
pre-processing the audio data by dividing the audio data into a plurality of frames;
extracting feature vectors from each of the plurality of frames using spectral analysis;
applying a time-delay neural network (TDNN) classifier to the extracted feature vectors to produce anchor model outputs, the TDNN classifier having been previously trained using a speaker training set containing known speakers;
normalizing the anchor model outputs to produce unit length anchor model output vectors;
clustering unit length anchor model output vectors into initial frame tags;
selecting a frame tag for a point in time;
assigning a weight to neighboring frame tags of the selected frame tag; and
determining whether to change the initial classification of the selected frame tag based on the weights and neighboring frame tags.

40. An audio processing system, comprising:
audio data that contains a plurality of unknown speakers;
anchor models that comprise a discriminatively-trained classifier that inputs the audio data and produces anchor model outputs; and
a mapping module that maps the anchor model outputs to frame tags, such that each of the frame tags correspond to a single one of the plurality of unknown speakers in the audio data

41. The audio processing system as set forth in claim 40, wherein the discriminatively-trained classifier is a convolutional neural network classifier.

42. The audio processing system as set forth in claim 41, wherein the convolutional neural network is a time-delay neural network (TDNN) classifier.

43. The audio processing system as set forth in claim 40, further comprising an audio pre-processing module for pre-processing the audio data.

44. The audio processing system as set forth in claim 43, wherein the audio pre-processing module further comprises a frame module that divides the audio data into a plurality of input frames.

45. The audio processing system as set forth in claim 44, wherein each of the plurality of input frames has a duration of at least 32 milliseconds.

46. The audio processing system as set forth in claim 44, wherein the audio pre-processing module further comprises a spectral features processor that extracts spectral feature magnitudes from each of the plurality of input frames.

47. The audio processing system as set forth in claim 40, further comprising a normalization module that produces normalized anchor model output vectors.

48. The audio processing system as set forth in claim 47, wherein the normalization module further comprises a unit sphere module that maps the modified anchor model output vectors to a unit sphere to produce anchor model output vectors having unit length.

49. The audio processing system as set forth in claim 40, wherein the mapping module further comprises a temporal sequential smoothing module for reducing frame tag error.

50. The audio processing system as set forth in claim 49, wherein the temporal sequential smoothing module further comprises a data selection module that inputs a set of frame tags produced by the mapping module and selects a frame tag from the set.

51. The audio processing system as set forth in claim 50, wherein the temporal sequential smoothing module further comprises a neighbor examination module that assign weights to each of the neighboring frame tags of the selected frame tag.

52. The audio processing system as set forth in claim 51, wherein the temporal sequential smoothing module further comprises a frame tag correction module that changes the selected frame tag based on weights and neighboring frame tags.

53. An audio processing system for classifying speakers within audio data, comprising:
a speaker training set containing known speakers;
a training system, producing parameters for a time-delay neural network (TDNN) classifier that distinguishes between the known speakers;
audio data containing unknown speakers;
a speaker classification system, comprising:
an audio pre-processing module for dividing the audio data into a plurality of frames and producing input feature vectors;
a TDNN classifier that uses the parameters produced by the training system and applies them to the input feature vectors to produce anchor model output vectors; and
a clustering module that clusters anchor model output vectors and assigns frame tags to each anchor model output vector.

54. The audio processing system as set forth in claim 53, wherein the training system comprises a cross-entropy error module.

55. The audio processing system as set forth in claim 54, wherein the training system comprises a mean-squared error module.

56. The audio processing system as set forth in claim 53, wherein each of the plurality of frames has a duration of at least 32 milliseconds.

57. The audio processing system as set forth in claim 53, wherein the clustering module further comprises a temporal sequential smoothing module that selects a frame tag and determines whether to change the frame tag based on weights and neighboring frame tags.

58. The audio processing system as set forth in claim 53, wherein each of the frame tags is associated with an input frame for the TDNN classifier and wherein each input frame contains approximately 1 second of the audio data.

59. The audio processing system as set forth in claim 53, wherein the audio pre-processing module further comprises an input frame of approximately 1 second duration that the TDNN classifier sees as input to the TDNN classifier.

60. The audio processing system as set forth in claim 59, wherein the input frame is associated with a frame tag.
